(19) United States
(12) Patent Application Publication
(10) Pub. No.: US 2022/0093958 A1
(43) Pub. Date: Mar. 24, 2022

(54) ION-CONDUCTING MEMBRANE FOR BATTERIES

(71) Applicant: International Business Machines Corporation, Armonk, NY (US)

(72) Inventors: YOUNG-HYE Na, San Jose, CA (US); Amaresh Samuthira Pandian, San Jose, CA (US); Khanh Nguyen, Morgan Hill, CA (US); PHILLIP MEDINA, San Jose, CA (US)

(21) Appl. No.: 17/030,539

(22) Filed: Sep. 24, 2020

(51) Int. Cl. H01M 10/056; H01M 10/0525; H01M 10/0585

(52) U.S. Cl. CPC H01M 10/056; H01M 10/0525; H01M 2300/0068; H01M 2300/0091; H01M 2300/0082; H01M 10/0585

(57) ABSTRACT

A method of manufacturing an ion-conducting film is provided. The method includes applying a layer of ion-conducting inorganic particles on an adhesive flexible substrate comprising a crosslinked siloxane polymer. The method also includes employing a physical pressing operation that embeds at least some of the particles into the adhesive substrate. The method also includes coating an electrically insulating polymer over the substrate, thereby forming a composite film that includes the insulating polymer and the particles. The method also includes peeling off the composite film from the adhesive flexible substrate. The method also includes removing a portion of the insulating polymer, thereby exposing particles in the composite film.

### BACKGROUND

The present disclosure relates to rechargeable batteries, and ion-conducting membranes used in these batteries. Certain rechargeable batteries utilize the intercalation of positive and negative electrodes to store ions. The ions shuttle between the electrodes during charge and discharge cycles of the battery. The ion movement between the electrodes may be facilitated with a liquid-based electrolyte. Additionally, replacing the intercalating negative electrode (e.g., graphite and hard carbon) with a metallic electrode (e.g., lithium and sodium) may be advantageous because the specific capacity of the metal electrodes is higher than the intercalating counterpart. This may allow for a reduction in the volume of the negative electrode because the energy delivered per unit volume (i.e., the energy density) is higher than the intercalating electrode. Consequently, there may not be a need to use additives like conductive carbon or a binder.

### SUMMARY

Embodiments of the present disclosure relate to method of manufacturing ion-conducting membranes. A method includes applying a layer of ion-conducting inorganic particles on an adhesive flexible substrate comprising a crosslinked siloxane polymer. The method also includes employing a physical pressing operation that embeds at least some of the particles into the adhesive substrate. The method also includes coating an electrically insulating polymer over the substrate, thereby forming a composite film that includes the insulating polymer and the particles. The method also includes peeling off the composite film from the adhesive flexible substrate. The method also includes removing a portion of the insulating polymer, thereby exposing particles in the composite film.

Other embodiments of the present disclosure relate to methods of manufacturing rechargeable batteries that include ion-conducting membranes. The method includes providing an anode, providing a cathode, and providing an ion-conducting film between the anode and the cathode. The ion-conducting film is formed by a method including applying a layer of ion-conducting inorganic particles on an adhesive flexible substrate comprising a crosslinked siloxane polymer. The method also includes employing a physical pressing operation that embeds at least some of the particles into the adhesive substrate. The method also includes coating an electrically insulating polymer over the substrate, thereby forming a composite film that includes the insulating polymer and the particles. The method also includes peeling off the composite film from the adhesive flexible substrate. The method also includes removing a portion of the insulating polymer, thereby exposing particles in the composite film.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, explain the principles of the disclosure. The drawings are only illustrative of certain embodiments and do not limit the disclosure.

FIG. 1 is a perspective view of the basic structure of an ion-conducting membrane, according to embodiments.

FIG. 2 is a flow chart describing a comparative example describing a method of manufacturing an ion-conducting membrane.

FIG. 3 is a flow chart describing a method of manufacturing an ion-conducting membrane, according to embodiments.

FIGS. 4A-4E are cross-sectional views of an ion-conducting membrane at various stages of the manufacturing process, according to embodiments.

FIGS. 5A-5B are examples of an ion-conducting membrane, according to embodiments.

FIGS. 6A-6C are examples of an ion-conducting membrane, according to embodiments.

It should be appreciated that elements in the figures are illustrated for simplicity and clarity. Well-understood elements that may be useful or necessary in a commercially feasible embodiment may not be shown for the sake of simplicity and to aid in the understanding of the illustrated embodiments.

### DETAILED DESCRIPTION

The present disclosure describes a composite ion-conducting membrane for batteries, and a method of preparing the composite ion-conducting membrane.

Various embodiments of the present disclosure are described herein with reference to the related drawings. Alternative embodiments can be devised without departing from the scope of the present disclosure. It is noted that various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements. It should be noted, the term “selective to,” such as, for example, “a first element selective to a second element,” means that a first element can be etched, and the second element can act as an etch stop.

The use of liquid-based electrolytes in the metallic anode system may promote the formation of needle-like crystals known as dendrites, which may lead to short-circuiting the battery. To suppress dendrite growth on the metallic anode surface, it may be desirable to develop a membrane/separator that has desirable mechanical strength with good ionic conductivity (e.g., higher than 10⁻⁵ S/cm or higher than 10⁻⁵ S/cm).

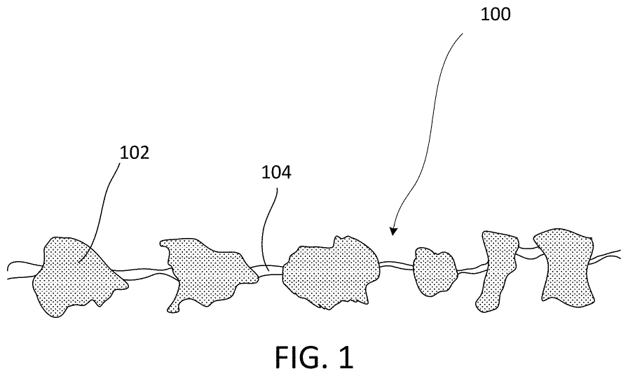

One example configuration of an ion-conducting membrane is shown in FIG. 1, and it is configured as a thin and flexible ion-conducting membrane 100. In this example configuration, the ion-conducting membrane 100 comprises a single-layered ion-conducting ceramic particle layer, where the particles 102 are inter-connected laterally through a non-ion-conducting (i.e., insulating) polymer binder 104. The thickness of the single-particle thick membrane can be adjusted by controlling the size of ceramic particles. The particles are connected circumferentially with the insulating polymer that leaves the top and bottom surface of the particle open for ion conduction. The membrane possesses high ionic conductance and effectively suppresses dendrite growth since the ceramic particle has a higher modulus than typical metallic anodes (e.g., Li, Na, etc.). Even though the polymer matrix has a lower shear modulus than that of the metallic anodes (not shown), the insulating nature of the polymer prevents dendrite growth towards the polymer matrix. Although this membrane has demonstrated a certain amount of potential for realizing high energy density lithium-metal batteries, the process operations required to fabricate the membrane 100 may be somewhat complex. It may be desirable to minimize the duration of the membrane preparation and to reduce the cost of the overall manufacturing process.

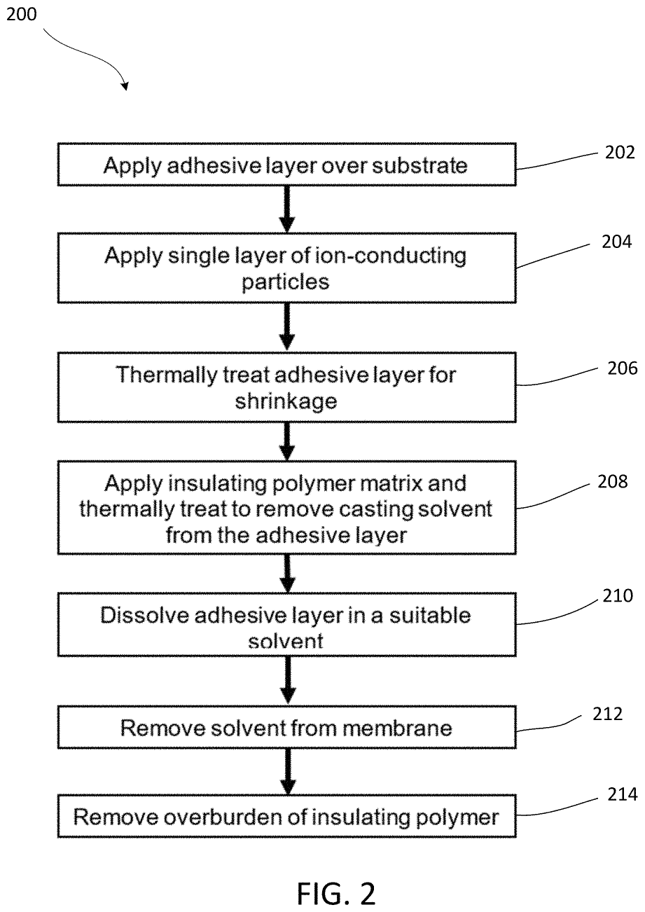

One example method of manufacturing an ion-conducting membrane is described in the flow chart of FIG. 2. In one example, the single-particle thick ceramic-polymer composite ion-conducting membrane is prepared using an adhesive tape or a PMGI (i.e., poly-dimethylglutarimide) based adhesive layer attached to a hard substrate. In operation 202, the adhesive tape layer is applied to the substrate. Other example adhesive tape constructions may include, but are not limited to, tapes available from Nitto Denko, Fremont, Calif., under the trade designations ELP UB 2130E, ELP DU-300, which can be either removed by the application of thermal energy or ultraviolet (UV) radiation; the PW (Pross Well)/TRM series of heat resistant adhesive tape from Nitto Denko; water soluble adhesive tape such as, for example, tapes with poly(vinyl) alcohol having a thin water soluble adhesive layer available from 3M, St. Paul, Minn., under the trade designation water soluble wave solder tape 5414; or, polyethylene oxide (PEO) adhesives containing the electrolyte lithium bistrifluoromethane sulfonyl imide (BTFMSI).

In operation 204, the particles are spread over the adhesive layer to form a single layer. The particles may be spread to form a regular or irregular array and may form a single layer over all or a portion of the adhesive layer. The particles are arranged in a single layer so that ions may conduct freely therethrough without encountering resistance at interfaces between overlying particles. The ion-conducting particles may optionally be sieved prior to application to the adhesive layer to ensure that the particles are more uniform in size and/or shape.

Additionally, during the tape manufacturing process, the tape may shrink while maintaining an elevated temperature. This shrinkage may disrupt the insulating polymer by displacing the ceramic particles and may result in curling of the membrane. Therefore, in certain examples, in operation 206 (i.e., before spraying an insulating polymer), the tape along with the single-layer ceramic is subjected to an elevated temperature to rearrange the particle before applying an insulating polymer.

In operation 208, the ion-conducting membrane is sprayed with an insulating polymer matrix. The matrix polymer layer may be applied by a wide variety of deposition techniques including, but not limited to, spinning, vapor phase deposition, dip coating, spraying and the like. Following and/or during application, the matrix polymer layer may optionally be further processed to improve its properties for use in subsequent process operations. For example, the matrix polymer may be heated or annealed to remove residual solvent and promote polymer flow, annealed in the presence of a plasticizing solvent in the vapor phase, exposed to radiation for hardening or crosslinking, and the like. For solution processing of the polymer, the polymer may be soluble in a casting solvent, or, if available as insoluble nanoparticles, they should preferably be dispersible in a solvent.

In operation 210, the membrane is released from the adhesive layer by dissolving the adhesive layer (e.g., the tape or PMGI layer) in an appropriate solvent. Example solvents may be ethanol or tetraethylammonium hydroxide for tape and PMGI processes, respectively. It should be appreciated that because the adhesive layer is completely dissolved that the adhesive layer cannot be reused.

The film that is exposed to solvents must undergo further thermal treatment under vacuum to remove the solvent used for removing the adhesive layer, as indicated in operation 212.

In operation 214, a certain portion of the insulating polymer matrix is removed. In certain examples, a portion of the matrix polymer layer is removed to expose a portion of at least some of the conducting particles, such that at least a portion of the particles protrude from the matrix polymer layer and have at least one surface that protrudes from a surface of the matrix polymer layer. The surface of each particle may be substantially free of the polymer making up the polymer layer. The portions of the matrix polymer layer can be removed by any suitable method, for example, soaking in aqueous or organic solvents, polishing, oxygen plasma etching, reactive ion etching, ion milling or any combination thereof. Ion milling may have a potential advantage of directional milling which may be useful for removing polymer from the tops of the particles in conformal coatings, while reducing the etch rate of the polymer making up the matrix polymer layer.

In the example method of manufacturing an ion-conducting membrane tape and PMGI discussed above with respect to FIG. 2, the processes are time-consuming, requiring multiple process operations with the use of a large quantity of solvent to release the adhesive layer. Furthermore, as mentioned above, the adhesive layer cannot be reused.

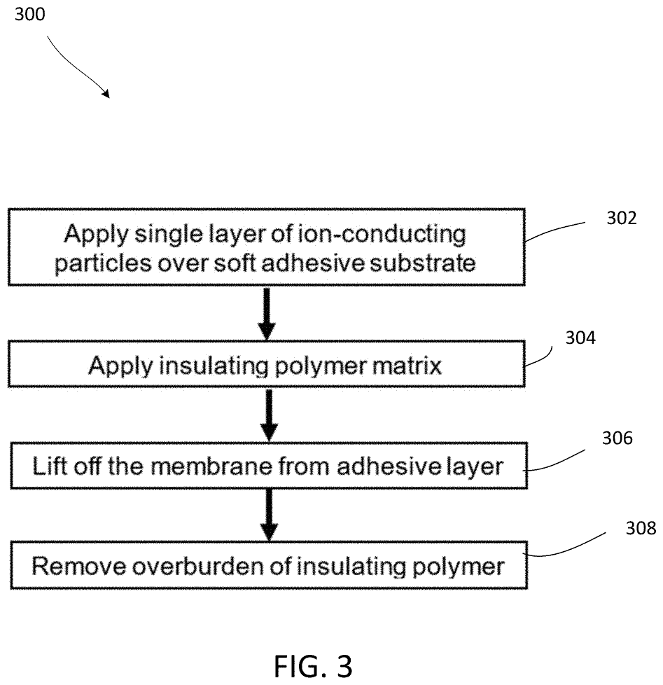

The present embodiments discussed below with respect to FIGS. 3-6C provide a simpler, more cost-effective method 300 of manufacturing an ion-conducting membrane relative to the example discussed above with respect to FIG. 2. The methods may also be compatible with a roll-to-roll manufacturing process, according to certain embodiments.

The present embodiments describe a process to fabricate a single particle thick composite ion-conducting membrane that utilizes a reusable sticky substrate, and that does not require using a sacrificial adhesive coating (e.g., the 3M tape or PMGI layer described above). According to the present embodiments, the processing time may be significantly reduced, and the process can be easily scaled up to roll-to-roll manufacturing. The present embodiments utilize a reusable adhesive layer (e.g., a soft elastic substrate that is formed by a crosslinkable siloxane material consisting of simple elements such as silicon, carbon, and oxygen). In certain examples, the crosslinked siloxane polymer comprises a [—SiRR′O-] moiety, wherein R and R′ are each independently selected from the group consisting of a hydrogen, an alkyl, an aryl, an alkylhalide, an arylhalide, and combinations thereof. In other examples, the crosslinked siloxane polymer is PDMS. In certain embodiments, there is no solvent involved in the adhesive removal step (e.g., as in operation 210 of FIG. 2) as the membrane can be easily peeled off from the reusable soft elastic substrate. Once the membrane is peeled from the crosslinked siloxane substrate, the free-standing substrate is ready for the next round of membrane fabrication. Therefore, the present embodiments may reduce the cost of fabricating single particle thick membrane and may reduce the number of processing operations.

An example method of manufacturing an ion-conducting membrane is described in the flow chart of FIG. 3, according to embodiments. In these embodiments, an adhesive substrate is used that is based on, for example, a crosslinked siloxane material (e.g., polydimethylsiloxane (PDMS)). In certain embodiments, the soft adhesive substrate is prepared by mixing a commercially available siloxane-based monomer with a curing agent.

In operation 302, the ion-conducting particles are spread over the free-standing adhesive substrate. The particles may be spread over the free-standing adhesive layer to form a single layer. The particles may be spread to form a regular or irregular array and may form a single layer over all or a portion of the free-standing adhesive substrate. The ion-conducting particles may optionally be sieved prior to application to the adhesive layer to ensure that the particles are more uniform in size and/or shape. In various embodiments, the mean particle size is less than 100 microns, and a mean particle size of less than 80 microns, less than 60 microns, less than 40 microns, or less than 25 microns may also be suitable. In certain embodiments, particles with a mean particle size less than 20 microns may be used. Smaller particles sizes may lead to higher ionic conductance, but average particle sizes of less than 1 micron may induce particle agglomeration and require additional process to produce reliable membranes with single-layered particle distribution. An average thickness of the membrane is dictated by the largest particles, and the size distribution may be less than 10% of the mean, such that the smallest particles may protrude through the opposing surfaces. In certain examples, in operation 302, the ion-conducting particles adhere to and/or become partially embedded in the free-standing adhesive substrate. In certain embodiments, the ion-conducting inorganic particles are selected from the group consisting of a non-oxide inorganic material, a perovskite-type oxide, a garnet-type oxide, a Li₃PO₄ oxide, a NASICON-type material, a LISICON-type material, lithium aluminum titanium phosphate (LATP), lithium aluminum germanium phosphate (LAGP), lithium aluminum tantalum titanium phosphate (LATTP), and combinations thereof. In certain embodiments, wherein the particles have an average size ranging from 1 to 100 μm.

In operation 304, an electrically insulating polymer matrix is sprayed over the particle array. In certain embodiments, the electrically insulating polymer is selected from the group consisting of an addition polymer, a ring opening metathesis polymer (ROMP), a hydrogenated cyclo-olefin polymer (COP), a cyclo-olefin copolymer (COC), and combinations thereof. The casting solvent for the insulating polymer is evaporated by thermal treatment and then the resulting single-particle thick ceramic-polymer membrane is physically separated from the adhesive soft substrate in operation 306. That is, in certain embodiments, after coating the electrically insulating polymer over the substrate, the method may comprise thermally evaporating volatile species from the electrically insulating polymer. Once the membrane is peeled off, the adhesive substrate is ready for another round of membrane fabrication. In other words, the same adhesive substrate can be used to repeat operations 302, 304 and 306 shown in FIG. 3.

In certain embodiments, in operation 308, a certain portion of the insulating polymer matrix is removed. In certain examples, a portion of the matrix polymer layer is removed to expose a portion of at least some of the conducting particles, such that at least a portion of the particles protrude from the matrix polymer layer and have at least one surface that protrudes from a surface of the matrix polymer layer. The surface of each particle may be substantially free of the polymer making up the polymer layer. The portions of the matrix polymer layer can be removed by any suitable method, for example, soaking in aqueous or organic solvents, polishing, oxygen plasma etching, reactive ion etching, ion milling or any combination thereof. Ion milling may have a potential advantage of directional milling which may be useful for removing polymer from the tops of the particles in conformal coatings, while reducing the etch rate of the polymer making up the matrix polymer layer. In certain embodiments, the operation of removing a portion of the insulating polymer to expose particles in the composite film may be performed before the operation of peeling off the composite film from the adhesive flexible substrate.

In certain embodiments, a method of manufacturing a battery utilizing the ion-conducting membrane discussed above is provided. The method may include providing an anode, providing a cathode, and providing an ion-conducting film between the anode and the cathode. In certain embodiments, the anode comprises at least one selected from the group consisting of graphite, silicon, an alkali metal, and an alkaline earth metal. In certain embodiments, the cathode comprises at least one selected from the group consisting of a metal oxide intercalation host, a metal phosphate intercalation host, a metal silicate intercalation host, sulfur, oxygen, iodide, and iodine. In certain embodiments, the method of manufacturing the battery includes providing a liquid electrolyte to fill empty voids in the battery. In certain embodiments, the method of manufacturing the battery includes comprising providing an additional ion-conducting material in between the ion-conducting film and the anode, and in between the ion-conducting film and the cathode.

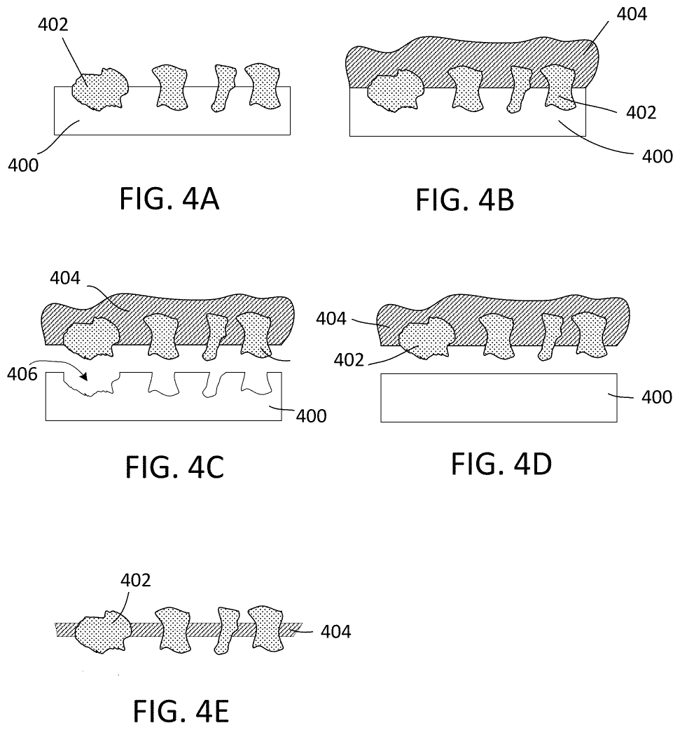

Referring now to FIGS. 4A-4E, an example ion-conducting polymer is shown in various stages of the manufacturing process described above with respect to FIG. 3. Specifically referring to FIG. 4A, a free-standing adhesive substrate 400 is provided. As discussed above, the free-standing adhesive substrate 400 may be, for example, a soft elastic substrate that is formed by a crosslinkable siloxane material consisting of simple elements such as silicon, carbon, and oxygen. In certain embodiments, the free-standing adhesive substrate 400 may allow for the ion-conducting particles 402 to adhere to the free-standing adhesive substrate 400. In certain embodiments, the ion-conducting particles 402 may be partially embedded into the surface of the free-standing adhesive substrate 400. In certain examples, the free-standing adhesive substrate 400 may be polydimethylsiloxane (PDMS). PDMS is a mineral-organic polymer with a structure consisting of silicon, carbon, and oxygen and belongs to the siloxane family of polymers. The monomer is a liquid and when mixed with a curing agent and may form a flexible polymer network with a high level of viscoelasticity. The clear, flexible and hardened PDMS adhesive film, as shown in FIG. 4A, may be used as an adhesive substrate for preparing ceramic-polymer composite membranes without further treatment. The PDMS substrate is capable of being reused several times.

As shown in FIG. 4B, after the ion-conducting particles 402 have been applied to the surface of the free-standing adhesive substrate 400 to form a single layer of particles, an insulating polymer matrix 404 is then applied to the surface of the free-standing adhesive substrate 400 and to cover the ion-conducting particles 402.

As shown in FIG. 4C, a combined ion-conducting layer including the ion-conducting particles 402 and the insulating polymer matrix 404 is removed from the free-standing adhesive substrate 400. As shown in FIG. 4D, in certain embodiments, the free-standing adhesive substrate 400 has a resiliency characteristic that allows for the free-standing adhesive substrate 400 to return to its original planar configuration (or at least substantially to the original shape). That is, to the extent that the ion-conducting particles 402 were partially embedded into the surface of the soft free-standing adhesive substrate 400, when the particles are later removed, and indentations 406 left by the ion-conducting particles 402 would tend to disappear as the free-standing adhesive substrate 400 returns to the original shape. Thus, the free-standing adhesive substrate 400 may be reused to form additional ion-conducting films.

Referring to FIG. 4E, in certain embodiments, after the ion-conducting particles 402 and insulating polymer matrix 404 are separated from the substrate, a certain amount of the insulating polymer matrix 404 may be removed. In particular, a portion of the insulating polymer matrix 404 is removed as needed to expose a portion of at least some of the ion-conducting particles 402, such that at least a portion of the ion-conducting particles 402 protrude from an upper surface of the insulating polymer matrix 404 layer. In certain embodiments, the surface of each particle 402 is substantially free of the polymer making up the insulating polymer matrix 404 layer. The portions of the insulating polymer matrix 404 can be removed by any suitable method, for example, soaking in aqueous or organic solvents, polishing, oxygen plasma etching, reactive ion etching, ion milling or any combination thereof.

In certain embodiments, the free-standing adhesive substrate 400 (e.g., PDMS) surface has enough stickiness for the ceramic particles to adhere to. In certain embodiments, the method of manufacturing the ion-conducting membrane may include, after one use of the PDMS substrate for a ceramic-polymer composite membrane, cleaning the surface of the free-standing adhesive substrate 400 with water to prepare for the next set of membranes. The effectiveness of the free-standing adhesive substrate 400 to hold the particles is demonstrated by a uniform and dense coating of the ion-conducting ceramic particles that are stuck on the surface even after reusing the same substrate, for example, ten times or more. Thus, the PDMS substrate in the present embodiments can be re-used multiple times and may obtain reliable ion-conducting membranes in every usage.

As opposed to other techniques of preparing composite electrolytes that involve physical mixing of ceramic particles with a polymer electrolyte to produce an ionically conductive polymer electrolyte, the present embodiments aim at preparing a membrane where ion conduction happens only through the ceramic particle in the membrane. Thus, it may be desirable to obtain a single layer of particles neatly arranged on the PDMS substrate. Therefore, embedding the ion-conducting particles into the free-standing adhesive substrate 400 is an effective to obtain the membrane. When a uniform layer of ceramic particles is deposited on the PDMS substrate, an insulating polymer is sprayed to obtain the single-particle thick membrane. In certain embodiments, this membrane is further treated with oxygen plasma etching to selectively remove part of the insulating polymer matrix that is struck on a top side (i.e., and air side) and a bottom side (i.e., a PDMS side) of the particles so that the membrane is still intact but the surface of the particles on the air side and PDMS side are exposed for ion conduction.

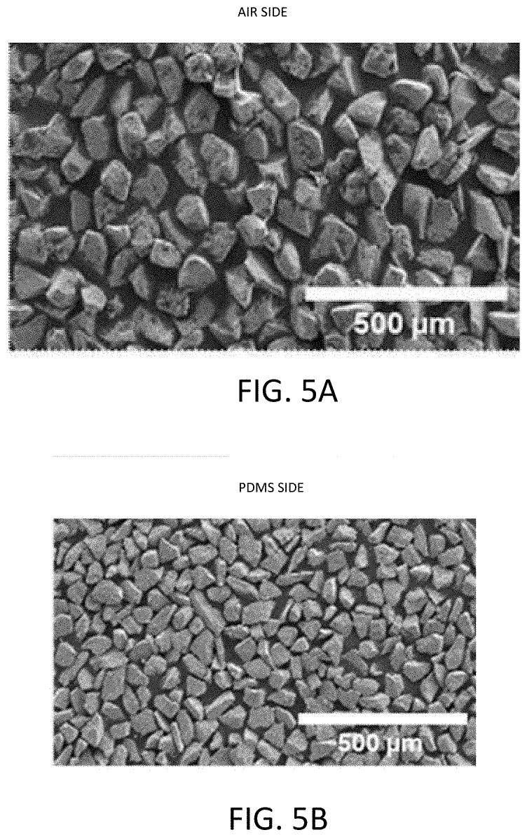

The final membrane having ceramic particles exposed at top and bottom for ion conduction connected by the insulating polymer matrix is shown in FIGS. 5A and 5B. The example membrane shown in FIGS. 5A and 5B includes ceramic particles of size ranging from 55 to 63 μm. Specifically, FIG. 5A shows the membrane when viewed from the air side, and FIG. 5B shows the same membrane when viewed from the PDMS side.

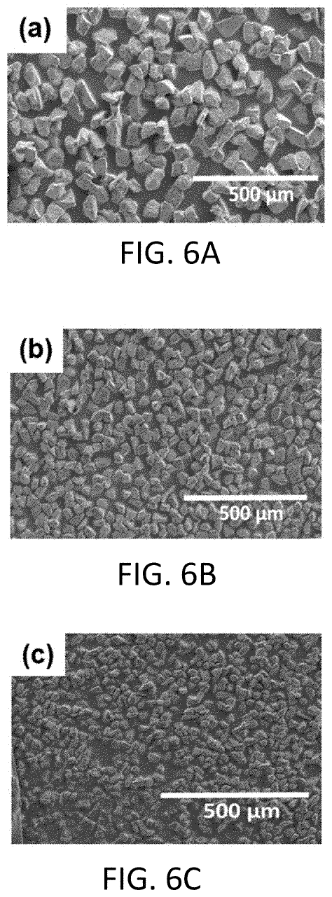

The methods described in the present embodiments may be used to obtain composite membranes consisting of particles of different sizes. A single particle thick membrane prepared by the method of the present embodiments using a PDMS adhesive substrate with particles sizes ranging from 45 to 53 μm is shown in FIG. 6A. A single particle thick membrane prepared by the method of the present embodiments using a PDMS adhesive substrate with particles sizes ranging from 32 to 38 μm is shown in FIG. 6B. A single particle thick membrane prepared by the method of the present embodiments using a PDMS adhesive substrate with particles sizes ranging from 25 to 32 μm is shown in FIG. 6C. The membranes prepared using different particle sizes are represented in FIGS. 6A-6C, and this demonstrates that the methods of the present embodiments may be used for preparing composite membranes with different particle sizes as the applications demand.

The electrical properties of the produced single-particle thick ion-conducting membrane were evaluated using impedance spectroscopy measurements. The impedance spectroscopy measurements were performed using lithium electrodes and a standard lithium electrolyte (1 M LiPF₆ in ethylene carbonate/dimethyl carbonate (EC/DMC)). The ionic conductivity of the membrane prepared using the present embodiments was measured at 1.0×10⁻⁴ S/cm at 25° C.

### Example 1: Preparation of PDMS Substrate

In one example, polydimethylsiloxane (PDMS) may be prepared as follows. A polymer kit may include a monomer and a curing agent, both liquids, in two separate containers. The monomer and the curing agent are physically mixed in a separate container in a ratio of 10:1. For example, 15 g of monomer is mixed with 1.5 g of curing agent. The mixture is treated for removing the air bubble under vacuum for 1 hour to obtain a clear liquid mixture. The mixture may be poured into a mold or coated over a hard substrate to obtain a soft adhesive film. The adhesive film is hardened by thermal curing at 75° C. for 1 hr. After the thermal treatment, the clear PDMS film can be easily separated from the hard mold to obtain a freestanding film that can be used as an adhesive substrate for ceramic-polymer composite membrane preparation.

### Example 2: Preparation of Single-Particle Thick Membrane

The ion-conducting ceramic particles LICGC™ are obtained from Ohara corporation having an ionic conductivity of 1.0×10⁻⁴ S/cm. The chemical composition of LICGC™ ceramic particles belongs to the Li₂O—Al₂O₃—SiO₂—P₂O₅—TiO₂ system. A single layer of the sieved ion-conducting particles ranging in size from, for example, 55 and 63 μm is spread evenly over the entire surface of the adhesive PDMS substrate by a simple agitation technique that involves creating vibrations. This operation is carried out until the entire film is covered with the ceramic particles. The ceramic particles may be partially embedded into the PDMS substrate by gently pressing them with a silicon rubber roller after covering the particles with a thin polytetrafluoroethylene (PTFE) film. After rolling, any excess, loosely bound particles are dusted out using an air blower. That is, after the pressing operation, in certain embodiments, the method may include blowing air over the adhesive substrate to remove any loose particles. Electronically and ionically insulating polymer matrix may then be coated over the single-layered ceramic particles. In one example, a cyclic olefin copolymer was used, ZEONOR 1430R from Zeon Corporation as the insulating polymer matrix as it shows a high modulus, low moisture absorption rate, and good thermal stability. For example, 1.5 g of ZEONOR 1430R is dissolved in 15.2 g of Decalin to obtain a 9% solution and sprayed over the ceramic particles. The ZEONOR solution is sprayed using the compressed gas at 30 psi. The distance between the spray nozzle and the target is maintained at 5 cm. One cycle of a coat consists of spraying along the horizontal as well as vertical direction of the target area. The directional shift is required for the uniform application of the polymer coat. A 30 second wait period is maintained between coats for the polymer to reach the entire circumference of the ceramic particle and to settle down. To reach the ideal thickness of the polymer coating to firmly hold ceramic particles, multiple coatings can be performed (total of six spray coatings has been employed for the particles sized 55-63 μm). After the spray coating, the ceramic particles are covered with a solution of ZEONOR. The solvent in the ZEONOR solution is thermally evaporated under the fume hood at 75° C. for 1 hr. The resulting membrane thus has a single layer of ceramic particles interlinked by the insulating polymer matrix. The membrane is physically peeled off from the PDMS adhesive substrate. Peeling off a membrane with particle interconnected by polymer is one of the features of the present embodiments.

The membrane is further treated by oxygen plasma to etch away the insulating polymer (called as polymer overburden) on both top (air side) and bottom (PDMS substrate side) of the ceramic particles. Although the polymer overburden is mostly on the air side, some etching might be needed for the PDMS side. The extent of etching depends on the amount of insulating polymer present. The etching should be precisely controlled for leaving enough insulating polymer to hold the particles laterally. In certain examples, an etch time of 6-10 minutes on the air side and a shorter time of about 1-2 minutes on the PDMS side may be employed, although the removal rate depends on the etching conditions. As mentioned above, FIGS. 5A and 5B show images of the single-particle thick membrane after etching overburden-insulating polymer to expose the top and bottom surfaces of ion-conducting ceramic particles.

### Example 3: Characterizing the Ionic Conductivity of the Single-Particle Thick Membrane

The ionic conductivity of the membrane was measured by electrochemical impedance spectroscopy (EIS). Several small signal (V=10 mV) AC impedance measurements were performed on a VMP3 impedance analyzer available from BioLogic Science Instruments, Seyssinet-Pariset, France, using sinusoidal AC waveforms. The frequency of the sinusoidal AC waveforms ranged from about 100 mHz to about 1 MHz. For EIS measurement, the membrane was placed in between two lithium electrodes. To avoid any side reaction of the metallic lithium electrode with the ceramic particles in the membrane, a polymer separator CELGARD 2325 soaked in 1M LiPF₆ EC/DMC (1/1 by volume) was placed as a support layer in between the membrane and the lithium electrode. The ionic conductivity of the membrane calculated from the EIS spectra is 1.0×10⁻⁴ S/cm at 25° C. that matches well with the industrial specification provided by Ohara Corporation for the particles.

### Example 4: Preparation of Single-Particle Thick Membrane with Particle Size Between 45 and 53 μm

The LICGC™ from Ohara corporation were sieved to obtain particles having sizes ranging from 45 and 53 μm. The single-particle thick membrane was prepared by following the procedure described in Example 2. To reach a desired thickness of the polymer coating to firmly hold ceramic particles, multiple coatings may be performed (a total of six spray coatings were employed for the particles sized 45-53 μm). The resulting membrane is shown in FIG. 6A.

### Example 5: Preparation of Single-Particle Thick Membrane with Particle Size Between 32 and 38 μm

The LICGC™ from Ohara corporation were sieved to obtain particles size ranging from 32 and 38 μm. The single-particle thick membrane is prepared by following the procedure described in Example 2. To reach the ideal thickness of the polymer coating to firmly hold ceramic particles, multiple coatings can be performed (total of four spray coatings were employed for the particles sized 32-38 μm). The resulting membrane is shown in FIG. 6B.

### Example 6: Preparation of Single-Particle Thick Membrane with Particle Size Between 25 and 32 μm

The LICGC™ from Ohara corporation were sieved to obtain particles size ranging from 25 and 32 μm. The single-particle thick membrane is prepared by following the procedure described in Example 2. To reach the ideal thickness of the polymer coating to firmly hold ceramic particles, multiple coatings can be performed (total of four spray coatings were employed for the particles sized 25-32 μm). The resulting membrane is shown in FIG. 6C.

The descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of manufacturing an ion-conducting film, the method comprising:
(a) applying a layer of ion-conducting inorganic particles on an adhesive flexible substrate comprising a crosslinked siloxane polymer;
(b) employing a physical pressing operation that embeds at least some of the particles into the adhesive substrate;
(c) coating an electrically insulating polymer over the substrate, thereby forming a composite film that includes the insulating polymer and the particles;
(d) peeling off the composite film from the adhesive flexible substrate; and
(e) removing a portion of the insulating polymer, thereby exposing one or more of the particles in the composite film.

2. The method of claim 1, wherein the particles cover at least 50% of a surface of the adhesive substrate to which the particles are applied.

3. The method of claim 1, wherein the electrically insulating polymer is not ion-conductive.

4. The method of claim 1, wherein the crosslinked siloxane polymer comprises a [—SiRR′O-] moiety, wherein R and R′ are each independently selected from the group consisting of a hydrogen, an alkyl, an aryl, an alkylhalide, an arylhalide, and combinations thereof.

5. The method of claim 1, wherein the crosslinked siloxane polymer is PDMS.

6. The method of claim 1, wherein the particles are selected from the group consisting of a non-oxide inorganic material, a perovskite-type oxide, a garnet-type oxide, a Li₃PO₄ oxide, a NASICON-type material, a LISICON-type material, lithium aluminum titanium phosphate (LATP), lithium aluminum germanium phosphate (LAGP), lithium aluminum tantalum titanium phosphate (LATTP), and combinations thereof.

7. The method of claim 1, wherein the particles have an average size ranging from 1 to 100 μm.

8. The method of claim 1, wherein an ionic conductivity of the ion-conducting film is at least 1.0×10⁻⁵ S/cm at 25° C.

9. The method of claim 1, further comprising, after the pressing operation, blowing air over the adhesive substrate to remove any loose particles.

10. The method of claim 1, wherein the electrically insulating polymer is selected from the group consisting of an addition polymer, a ring opening metathesis polymer (ROMP), a hydrogenated cyclo-olefin polymer (COP), a cyclo-olefin copolymer (COC), and combinations thereof.

11. The method of claim 1, wherein operations (a) and (b) are repeated at least once prior to performing operations (c)-(e).

12. The method of claim 1, wherein operation (e) is performed prior to operation (d).

13. The method of claim 1, wherein after coating the electrically insulating polymer over the substrate, the method further comprises thermally evaporating volatile species from the electrically insulating polymer.

14. A method of manufacturing a battery, the method comprising:
providing an anode;
providing a cathode; and
providing an ion-conducting film between the anode and the cathode, the ion-conducting film being formed by:
(a) applying a layer of ion-conducting inorganic particles on an adhesive flexible substrate comprising a crosslinked siloxane polymer;
(b) employing a physical pressing operation that embeds at least some of the particles into the adhesive substrate;
(c) coating an electrically insulating polymer over the substrate, thereby forming a composite film that includes the insulating polymer and the particles;
(d) peeling off the composite film from the adhesive flexible substrate; and
(e) removing a portion of the insulating polymer, thereby exposing one or more of the particles in the composite film.

15. The method of claim 14, wherein the anode comprises at least one selected from the group consisting of graphite, silicon, an alkali metal, and an alkaline earth metal.

16. The method of claim 14, wherein the cathode comprises at least one selected from the group consisting of a metal oxide intercalation host, a metal phosphate intercalation host, a metal silicate intercalation host, sulfur, oxygen, iodide, and iodine.

17. The method of claim 14, wherein the crosslinked siloxane polymer comprises a [—SiRR′O-] moiety, wherein R and R′ are each independently selected from the group consisting of a hydrogen, an alkyl, an aryl, an alkylhalide, an arylhalide, and combinations thereof.

18. The method of claim 14, wherein the particles are selected from the group consisting of a non-oxide inorganic material, a perovskite-type oxide, a garnet-type oxide, a Li₃PO₄ oxide, a NASICON-type material, a LISICON-type material, lithium aluminum titanium phosphate (LATP), lithium aluminum germanium phosphate (LAGP), lithium aluminum tantalum titanium phosphate (LATTP), and combinations thereof.

19. The method of claim 14, further comprising providing a liquid electrolyte to fill empty voids in the battery.

20. The method of claim 14, further comprising providing an additional ion-conducting material between the ion-conducting film and the anode, and between the ion-conducting film and the cathode.
